(19) United States
(12) Patent Application Publication
(10) Pub. No.: US 2026/0113273 A1
(43) Pub. Date: Apr. 23, 2026

(54) CONGESTION DETECTION IN STORAGE NETWORKS

(71) Applicant: Dell Products L.P., Round Rock, TX (US)

(72) Inventors: Scott Rowlands, Cumming, GA (US); Igor Fradkin, Sharon, MA (US); Arieh Don, Newton, MA (US)

(73) Assignee: Dell Products L.P., Round Rock, TX (US)

(21) Appl. No.: 18/924,134

(22) Filed: Oct. 23, 2024

(51) Int. Cl. H04L 47/12; H04L 67/1097

(52) U.S. Cl. CPC H04L 47/12; H04L 67/1097

(57) ABSTRACT

One or more aspects of the present disclosure relate to detecting and mitigating congestion in a storage area network. In embodiments, peer congestion Fabric Performance Impact Notification (FPIN) messages can be used to infer congestion on a target port that has not received a direct congestion FPIN. Upon receiving a peer congestion FPIN for a target port, the embodiments determine if the target port received a direct congestion FPIN. If not, the embodiments infer congestion on the target port based on the peer notification. The embodiments then control messaging to the congested port to mitigate the congestion, such as by adjusting bandwidth limits. This approach enables congestion detection and mitigation even when severe congestion prevents the delivery of direct notifications to the affected port. Accordingly, the embodiments leverage existing FPIN infrastructure and connectivity information to provide a simple, standards-based solution for identifying and addressing congestion issues in storage networks.

### BACKGROUND

Storage Area Networks (SANs) are specialized high-speed networks interconnect data storage devices with data servers. SANs typically use Fibre Channel (FC) protocols for communication between servers and storage devices. In FC SANS, switches and directors facilitate data routing between initiators (typically servers) and targets (typically storage arrays). Maintaining optimal performance becomes increasingly challenging as SAN environments grow in complexity and scale. Link integrity issues, bandwidth mismatches, and oversubscription can lead to congestion and degraded performance.

### SUMMARY

One or more aspects of the present disclosure relate to One or more aspects of the present disclosure relate to detecting and mitigating congestion in a storage area network. In embodiments, a peer congestion Fabric Performance Impact Notification (FPIN) message indicating congestion for a target port of the storage array is received at a storage array port. A determination is made that the target port has not received a direct congestion FPIN message. Based on the received peer congestion FPIN message and the determination, it is inferred that the target port is experiencing congestion. Further, messaging to the target port is controlled to mitigate the congestion.

In embodiments, multiple ports of the storage array can be inspected to identify received peer congestion FPIN messages related to the target port.

In embodiments, all ports of the storage array in a specific zone of the storage array corresponding to the target port can be inspected to identify ports receiving peer congestion FPINs for the target port.

In embodiments, a World Wide Name (WWN) of the target port experiencing congestion can be extracted from the peer congestion FPIN message.

In embodiments, a connectivity table of the storage array can be searched for the extracted WWN of the target port.

In embodiments, the connectivity table of the storage array can be searched to identify a switch port WWN connected to the target port.

In embodiments, bandwidth limits on the target port can be adjusted to mitigate the inferred congestion on the target port.

In embodiments, the peer congestion FPIN message on a subject storage array port can be received on a zone corresponding to the target port.

In embodiments, whether the congestion on the target port is preventing the target port from receiving a direct congestion FPIN message can be determined.

In embodiments, a congestion notification for the target port can be generated as if the target port had received a direct congestion FPIN message from a connected switch port.

Other technical features may be readily apparent to one skilled in the art from the following figures, descriptions, and claims.

### BRIEF DESCRIPTION OF THE DRAWINGS

The preceding and other objects, features, and advantages will be apparent from the following more particular description of the embodiments, as illustrated in the accompanying drawings. Like reference, characters refer to the same parts throughout the different views. The drawings are not necessarily to scale, emphasis instead being placed upon illustrating the embodiments' principles.

FIG. 1 illustrates a distributed network environment in accordance with embodiments of the present disclosure.

FIG. 2 is a block diagram of engines of a storage array, including director boards, in accordance with embodiments of the present disclosure.

FIG. 3 is a block diagram of a communications network in accordance with embodiments of the present disclosure.

FIG. 4 is a flow diagram of a method for detecting congestion in storage networks per embodiments of the present disclosure.

### DETAILED DESCRIPTION

Storage Area Networks (SANs) are critical infrastructures that connect servers to storage devices in enterprise data centers. However, SANs can experience performance issues like congestion and link failures that severely impact applications and business operations. Traditionally, detecting and resolving these issues has been challenging, often taking weeks or months to diagnose and fix problems. For example, SANs can face significant challenges related to marginal links and congestion. Bad optics, cables, or connectivity can cause marginal links. Congestion often results from oversubscription, credit loss, or credit stall situations. These issues can be pervasive, affecting thousands of data flows simultaneously. The impact can lead to application stalls lasting tens of seconds, crashes, and outages. Detecting and resolving these problems traditionally takes weeks or even months.

A fundamental problem is that when congestion or other issues occur, the affected devices and administrators may not be promptly notified or have enough information to address the root cause quickly. This leads to finger-pointing between server, network, and storage teams, prolonging outages. For instance, previous approaches to addressing SAN congestion have limitations. When performance issues arise, there is often confusion and finger-pointing between application support teams, storage administrators, and network administrators. This can lead to prolonged troubleshooting cycles and delayed resolution of critical issues.

To solve this, embodiments of the present disclosure include a new system of Fabric Notifications developed and standardized for Fibre Channel SANs. The SAN fabric generates these notifications to inform affected devices and administrators about performance impairments immediately. The notifications provide detailed information about the nature and location of issues. By enabling proactive and automated responses to SAN performance issues, Fabric Notifications significantly improve the reliability and resiliency of enterprise storage networks.

For example, embodiments of the present disclosure can detect congestion on a specific array port in a storage area network. Specifically, the embodiments can leverage Fabric Performance Impact Notifications (FPINs), which are Extended Link Service (ELS) messages carried over Fibre Channel frames.

The embodiments can receive a peer congestion FPIN message at a storage array port, indicating congestion for a target port of the storage array. Additionally, the embodiments can determine that the target port has not received a direct congestion FPIN message. Based on the received peer congestion FPIN message and the determination, the embodiments can infer that the target port is experiencing congestion. Further, the embodiments can control messaging to the target port to mitigate congestion.

Advantageously, the embodiments address a crucial limitation of the current FPIN standard. While there are four types of FPIN ELS events (link integrity, delivery, congestion, and peer congestion), the congestion FPIN does not include the “attached” or “detecting” World Wide Names (WWNs) that are present in the other FPIN types. This makes it challenging to identify the source of congestion problems.

To overcome this limitation, the embodiments can use the array port WWN receiving the congestion FPIN as the “attached” WWN (the port causing the issue). For the “detecting” WWN (the switch port reporting the issue), the embodiments can use a storage array's internal connectivity table to find the switch port WWN connected to the affected array port.

The embodiments can further inspect multiple ports of the storage array to identify received peer congestion FPIN messages related to the target port. This can involve examining all ports in a specific zone of the storage array corresponding to the target port. Upon detecting congestion, the embodiments can take automated actions to mitigate the issue. This can include adjusting bandwidth limits on the target port or generating a congestion notification for the target port as if it had received a direct congestion FPIN message from a connected switch port.

Accordingly, the embodiments allow congestion detection even when a congestion FPIN has not been received directly by the affected port. Additionally, the embodiments do not require hardware or software support for a specialized congestion signal, making it compatible with older array hardware. Thus, the embodiments provide a standardized way to handle congestion FPINs, simplifying automation and reducing the need for manual intervention by storage administrators.

This methodology is advantageous in scenarios where storage arrays with newer, higher-speed ports (e.g., 32G FC) are deployed in SANs containing hosts with older, lower-speed HBAs (e.g., 8G). In such cases, the mismatch in port speeds can lead to congestion that is difficult to diagnose and resolve using traditional methods.

By leveraging peer congestion FPINs and internal connectivity information, the embodiments can proactively detect and respond to congestion issues, improving overall SAN performance and reliability.

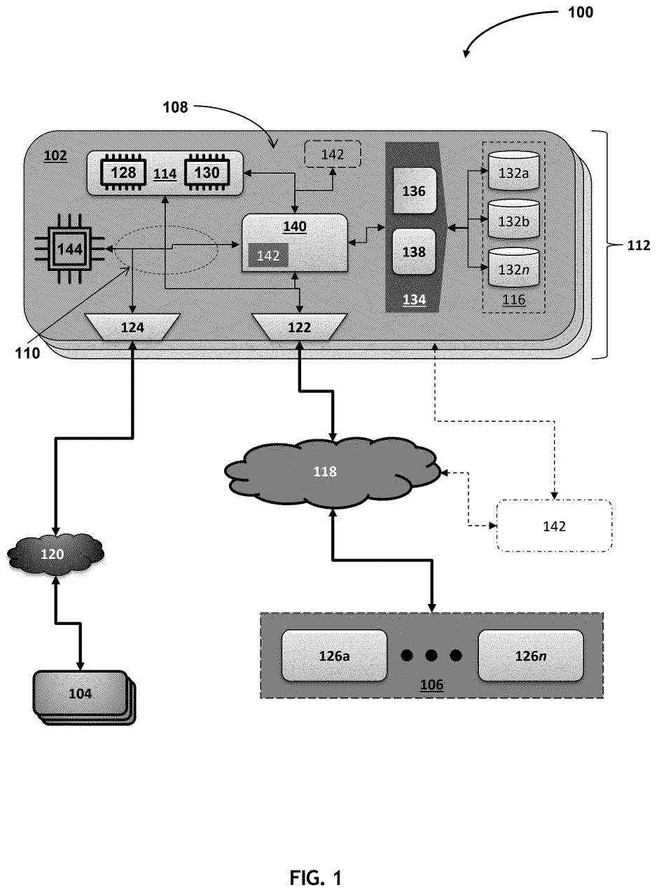

Regarding FIG. 1, a distributed network environment 100 can include a storage array 102, a remote system 104, and hosts 106. In embodiments, the storage array 102 can include components 108 that perform one or more distributed file storage services. In addition, the storage array 102 can include one or more internal communication channels 140 like Fibre channels, busses, and communication modules that communicatively couple the components 108. Further, the distributed network environment 100 can define an array cluster 112, including the storage array 102 and one or more other storage arrays.

In embodiments, the storage array 102, components 108, and remote system 104 can include a variety of proprietary or commercially available single or multi-processor systems (e.g., parallel processor systems). Single or multi-processor systems can include central processing units (CPUs), graphical processing units (GPUs), and others. Additionally, the storage array 102, remote system 104, and hosts 106 can virtualize one or more of their respective physical computing resources (e.g., processors (not shown), memory 114, and persistent storage 116).

In embodiments, the storage array 102 and, e.g., one or more hosts 106 (e.g., networked devices) can establish a network 118. Similarly, the storage array 102 and a remote system 104 can establish a remote network 120. Further, the network 118 or the remote network 120 can have a network architecture that enables networked devices to send/receive electronic communications using a communications protocol. For example, the network architecture can define a storage area network (SAN), local area network (LAN), wide area network (WAN) (e.g., the Internet), an Explicit Congestion Notification (ECN), Enabled Ethernet network, and the like. Additionally, the communications protocol can include a Remote Direct Memory Access (RDMA), TCP, IP, TCP/IP protocol, SCSI, Fibre Channel, Remote Direct Memory Access (RDMA) over Converged Ethernet (ROCE) protocol, Internet Small Computer Systems Interface (ISCSI) protocol, NVMe-over-fabrics protocol (e.g., NVMe-over-ROCEv2 and NVMe-over-TCP), and the like.

Further, the storage array 102 can connect to the network 118 or remote network 120 using one or more network interfaces. The network interface can include a wired/wireless connection interface, bus, data link, and the like. For example, a host adapter (HA 122), e.g., a Fibre Channel Adapter (FA) and the like, can connect the storage array 102 to the network 118 (e.g., SAN). Further, the HA 122 can receive and direct IOs to one or more of the storage array's components 108, as described in greater detail herein.

Likewise, a remote adapter (RA 124) can connect the storage array 102 to the remote network 120. Further, the network 118 and remote network 120 can include communication mediums and nodes that link the networked devices. For example, communication mediums can include cables, telephone lines, radio waves, satellites, infrared light beams, etc. The communication nodes can also include switching equipment, phone lines, repeaters, multiplexers, and satellites. Further, the network 118 or remote network 120 can include a network bridge that enables cross-network communications between, e.g., the network 118 and remote network 120.

In embodiments, hosts 106 connected to the network 118 can include client machines 126a-n, running one or more applications. The applications can require one or more of the storage array's services. Accordingly, each application can send one or more input/output (IO) messages (e.g., a read/write request or other storage service-related request) to the storage array 102 over the network 118. Further, the IO messages can include metadata defining performance requirements according to a service level agreement (SLA) between hosts 106 and the storage array provider.

In embodiments, the storage array 102 can include a memory 114, such as volatile or nonvolatile memory. Further, volatile and nonvolatile memory can include random access memory (RAM), dynamic RAM (DRAM), static RAM (SRAM), and the like. Moreover, each memory type can have distinct performance characteristics (e.g., speed corresponding to reading/writing data). For instance, the types of memory can include register, shared, constant, user-defined, and the like. Furthermore, in embodiments, the memory 114 can include global memory (GM 128) that can cache IO messages and their respective data payloads. Additionally, the memory 114 can include local memory (LM 130) that stores instructions that the storage array's processors 144 can execute to perform one or more storage-related services. For example, the storage array 102 can have a multi-processor architecture that includes one or more CPUs (central processing units) and GPUs (graphical processing units).

In addition, the storage array 102 can deliver its distributed storage services using persistent storage 116. For example, the persistent storage 116 can include multiple thin-data devices (TDATs) such as persistent storage drives 132a-n. Further, each TDAT can have distinct performance capabilities (e.g., read/write speeds) like hard disk drives (HDDs) and solid-state drives (SSDs).

Further, the HA 122 can direct one or more IOs to an array component 108 based on their respective request types and metadata. In embodiments, the storage array 102 can include a device interface (DI 134) that manages access to the array's persistent storage 116. For example, the DI 134 can include a disk adapter (DA 136) (e.g., storage device controller), flash drive interface 138, and the like that control access to the array's persistent storage 116 (e.g., storage devices 132a-n).

Likewise, the storage array 102 can include an Enginuity Data Services processor (EDS 140) that can manage access to the array's memory 114. Further, the EDS 140 can perform one or more memory and storage self-optimizing operations (e.g., one or more machine learning techniques) that enable fast data access. Specifically, the operations can implement techniques that deliver performance, resource availability, data integrity services, and the like based on the SLA and the performance characteristics (e.g., read/write times) of the array's memory 114 and persistent storage 116. For example, the EDS 140 can deliver hosts 106 (e.g., client machines 126a-n) remote/distributed storage services by virtualizing the storage array's memory/storage resources (memory 114 and persistent storage 116, respectively).

In embodiments, the storage array 102 can also include a controller 142 (e.g., management system controller) that can reside externally from or within the storage array 102 and one or more of its components 108. When external from the storage array 102, the controller 142 can communicate with the storage array 102 using any known communication connections. For example, the communications connections can include a serial port, parallel port, network interface card (e.g., Ethernet), etc. Further, the controller 142 can include logic/circuitry that performs one or more storage-related services. For example, the controller 142 can have an architecture designed to manage the storage array's computing, processing, storage, and memory resources as described in greater detail herein.

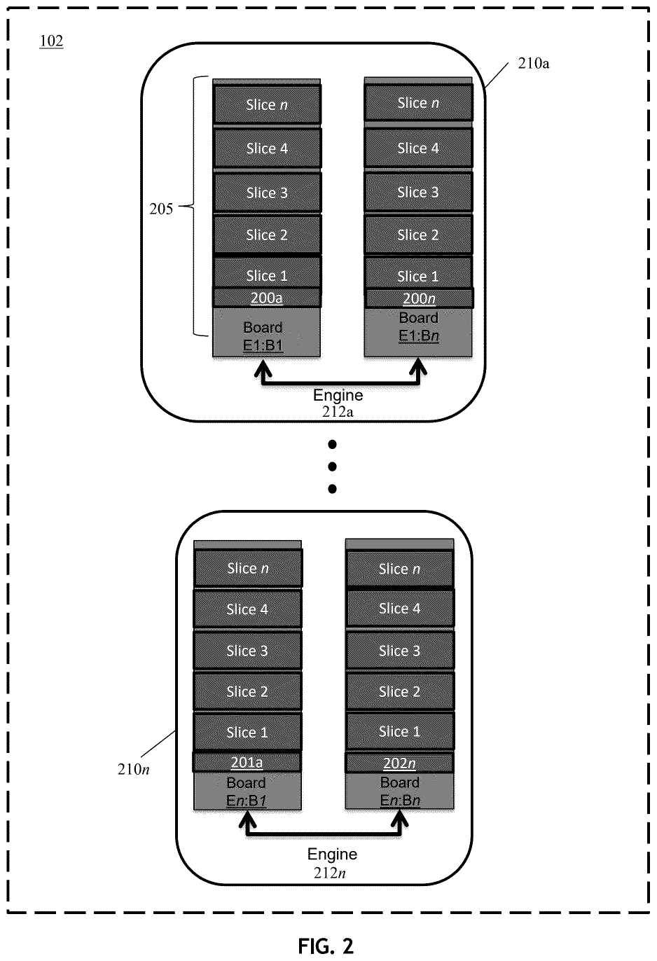

Regarding FIG. 2, the storage array 102 includes engines 212a-n that deliver storage services. Each engine 212a-n has hardware circuitry or software components required to perform the storage services. Additionally, the array 102 can house each engine 212a-n in one or more of its shelves (e.g., housing) 210a-n that interface with the array's cabinet or rack (not shown).

In embodiments, each engine 212a-n can include director boards (boards) E1:B1-E1:Bn, En:B1-En:Bn. The boards E1:B1-E1:Bn, En:B1-En:Bn can have slices 205, each comprising hardware or software elements that perform specific storage services. Each board's slices 1-n can correspond to or emulate one or more of the storage array's components 108 described in FIG. 1. For example, each board's Slice 1 can correspond to or emulate the EDS 140 or controller 142 of FIG. 1. In embodiments, the slices 2-n can emulate one or more of the array's other components 101. Further, the boards B1-n can include memory 200a-n-201a-n, respectively. The memory 200a-n-201a-n can be dynamic random-access memory (DRAM).

In embodiments, each emulated EDS 140 (collectively “EDS 140”) can provision its respective board with memory from the array's global memory 128. For example, the EDS 140 can uniformly carve out at least one global memory section into x-sized memory portions 200a-n-201a-n. Further, the EDS 140 can size each global memory section or the x-sized memory portions 200a-n-201a-n to store data structure filters like cuckoo filters. The EDS 140 can size each global memory section or the x-sized portions based on an IO workload's predicted metrics related to the amount and frequency of sequential IO write patterns. For instance, the predicted metrics can define the amount of data the x-sized memory portions 200a-n-201a-n can be required to store.

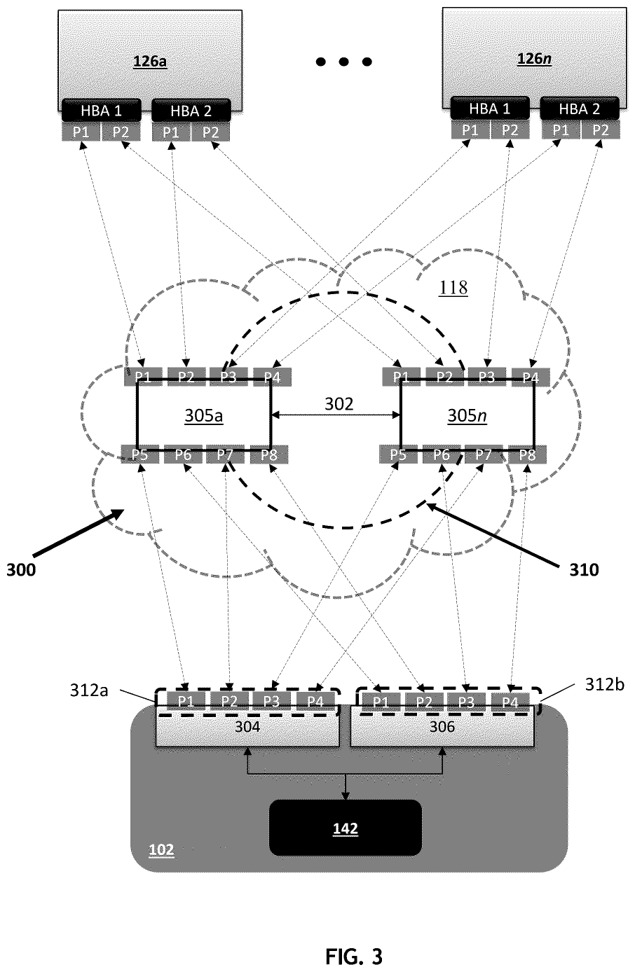

Regarding FIG. 3, a network (e.g., a storage area network) 118 can include one or more interconnected nodes (e.g., switches) 305a-n that define a structure and flow of information between devices on the network 118. In embodiments, the network can interconnect the nodes 305a-n using links 310. The links 310 can allow the nodes 305a-n to exchange messages using one or more communication protocols. The communications protocols can define a method (e.g., rules, syntax, semantics, and the like) by which the nodes 305a-n can pass messages and signals to other networked devices. Further, the protocol can define a communications synchronization process and error recovery methods. The network 118 can implement the protocol using hardware, software, or a combination of both. The protocol's rules, syntax, and semantics can include, e.g., a circuit switching, message switching, or packet switching technique. In embodiments, the nodes 305a-n can comprise networking hardware such as computing nodes (e.g., computers), servers, networking hardware, bridges, switches, hubs, and the like.

For example, the nodes 305a-n can correspond to Fibre Channel (FC) switches connected via an inter-switch link (ISL) 302. The ISL 302 allows for communication and data transfer between switches, enabling the creation of larger fabric topologies and providing redundancy. ISLs are typically high-speed links that carry traffic between switches, allowing devices connected to different switches to communicate with each other as if they were on the same switch. In the context of SAN FC Zoning, ISLs are crucial in connecting multiple switches to form a larger, more flexible network infrastructure.

The network 118 can arrange the nodes 305a-n to define one or more of a Chain Network (CHN), Y-Network (YN), Wheel Network (WN), Circle Network (CIRN), All-Channel Network (ACN) such as a Star Network, and the like. In a CHN, the nodes 305a-n have a hierarchical relationship (e.g., topology) that requires communications to flow through a formal chain. In a YN, the nodes 305a-n have a topology resembling an upside-down ‘Y’ (e.g., information flows upward and downward through the hierarchy). In a WN, data flows to and from a networked device (e.g., array 102). In a CIRN, the nodes 305a-n have a topology that restricts the flow of information to/from one node of the nodes to an adjacent node (e.g., a neighboring node). In embodiments, each node can have at most two adjacent nodes. In an ACN, the nodes 305a-n have a structure that allows communications to flow upward, downward, and laterally among each node. As illustrated, the network 118 can have an arrangement 300 consistent with an ACN. In embodiments, the network 118 can define one or more communication paths between the array 102 and hosts 1226a-n.

In embodiments, hosts 126a-n can connect to the network (e.g., SAN) 119 using Host Bus Adapters (HBAs) (e.g., respective HBAs 1-2) that are substantially similar to Network Interface Cards (NICs) in Ethernet networks. Each HBA (respective HBAs 1-2) includes ports P1-2 that are assigned unique World Wide Names (WWNs). The HBA ports P1-2 can connect to switch ports (e.g., ports P1-4 of switches 305a-n) via Fibre Channel links.

In embodiments, FC switches (e.g., switches 305a-n) can include multiple ports P1-8, each with its own WWN. The switches 305a-n can include switch host ports P1-4 connected to hosts. The switches 305a-n can also include switch storage ports P5-8 connected to one or more storage arrays (e.g., the storage array 102). Further, the switches 305a-n can be interconnected using Inter-Switch Links (ISLs) for redundancy and expanded connectivity.

In embodiments, a storage array 102 can include director boards 304/306 (e.g., substantially similar to director boards En:Bn of FIG. 2), each including a small input/output (IO) card (SLIC) 312a-b. Each SLIC can include multiple FC ports (e.g., ports P1-4) connected to corresponding switch storage ports P5-8 of respective switches 305a-n. Like other components (e.g., ports) of the network 118, the FC ports P1-4 on each SLIC 312a-b are assigned World Wide Names (WWNs). The SLICs 312a-b provide an interface between the storage array 102 and the external fabric corresponding to the network 118. Accordingly, the SLICs 312a-b allow the storage array 102 to connect to multiple FC switches (e.g., the FC switches 305a-n).

In embodiments, WWNs are unique identifiers in Fibre Channel networks, similar to IP addresses in Ethernet networks. Each device (e.g., HBA port, switch port, storage array port) is assigned a unique WWN. The WWNs can identify each device and port in the SAN 118. Additionally, the WWNs can be used to create logical zones that define which devices can communicate with each other. Specifically, zoning techniques use WWNs to create logical groups of devices that are allowed to communicate. Further, networked devices (e.g., the hosts 126a-n, FC switches 305a-n, and storage array 102) on the SAN 118 can implement multipathing techniques that use the WWNs to identify and manage multiple paths between the networked devices. Using WWNs, SAN administrators can precisely control and manage connectivity, security, and resource allocation in the Fibre Channel network, ensuring that only authorized devices can communicate and access specific resources.

In embodiments, the storage array 102 can include a controller 142 that detects and mitigates congestion in the SAN 118. For instance, the controller 142 can receive Fabric Performance Impact Notifications (FPINs) from the SAN fabric. The FPINs can include congestion FPINs and peer congestion FPINs. The controller 142 can extract relevant information from these notifications, such as the World Wide Names (WWNs) of affected ports and switches.

Specifically, congestion FPINs and peer congestion FPINs are two types of Fabric Performance Impact Notifications used in Storage Area Networks (SANs) to detect and report congestion issues.

Regarding congestion FPINS, the switches 305a-n can directly send congestion FPINs to a subject storage array port (e.g., one of the ports P1-4 of director boards 304/306) experiencing congestion. However, the congestion FPINs do not include the World Wide Names (WWNs) of the detecting switch port or the attached/affected storage port and are used to inform the subject storage array port of its congestion state.

Regarding peer congestion FPINs, the switches 305a-n can send peer congestion FPINs to all ports zoned with the congested port. The peer congestion FPINs include the WWN of the congested port (also called the “attached” port) in their payload. Accordingly, peer congestion FPINs allow the ports to infer congestion on a specific port even if that port hasn't received a direct congestion FPIN.

Further, each operation can include any combination of techniques implemented by the embodiments described herein. Additionally, one or more of the storage array's components 108 can implement one or more of the operations of each method described above.

In embodiments, the controller 142 can inspect the ports P1-4 of the director boards 304/306 to identify received peer congestion FPIN messages related to a target port (e.g., a congested port). For example, the controller 142 inspects all ports in a specific zone corresponding to the target port to detect congestion patterns. Suppose the controller 142 detects that array ports are receiving peer congestion FPIN messages against a particular array port, but that port isn't receiving direct congestion FPIN messages. In that case, it infers that the port is severely congested. This inference is crucial when congestion prevents the delivery of direct congestion notifications to the affected port.

Further, the controller 142 can maintain and search an internal connectivity table (e.g., stored in the GM 128 of the storage array 102 of FIG. 1) to correlate port WWNs with their physical connections. This allows the controller 142 to identify which switch ports are connected to which array ports, enabling more precise congestion localization.

In embodiments, when an affected port does not receive a direct congestion FPIN, the controller 142 can generate congestion reports for inferred congestion using existing reporting infrastructure. This ensures administrators are alerted to congestion issues, even when traditional notification methods fail.

Based on user-defined policies or automated decisions, the controller 142 can deploy host bandwidth limits on congested ports to mitigate the congestion. This function allows for dynamic adjustment of IO rates to prevent congestion from spreading or worsening. In advanced implementations, the controller 142 can automatically throttle IOs to congested hosts upon receipt of congestion notifications without requiring administrator intervention.

Additionally, the controller 142 can facilitate communication between array ports, allowing them to share information about received peer congestion notifications and infer the state of potentially congested ports that aren't receiving direct notifications. Further, the controller 142 can send congestion event information to management systems, enabling centralized monitoring and alerting. The controller 142 can also interface with syslog systems for broader IT operations visibility.

The controller 142 performs the functions described herein by continuously monitoring FPIN messages, analyzing traffic patterns, and making intelligent decisions based on the SAN's state. Furthermore, the controller 142 can leverage the storage array's knowledge of its own connectivity and the broader SAN topology to provide a more comprehensive and proactive approach to congestion management than traditional methods.

The following text includes details of a method(s) or a flow diagram(s) per embodiments of this disclosure. For simplicity of explanation, each method is depicted and described as a set of alterable operations. Additionally, one or more operations can be performed in parallel, concurrently, or in a different sequence. Further, not all the illustrated operations are required to implement each method described by this disclosure.

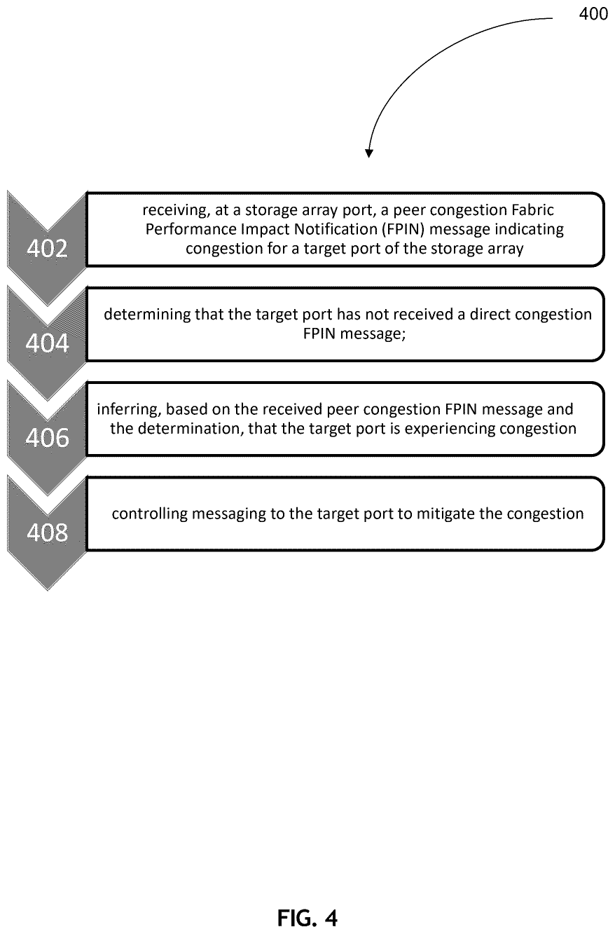

Regarding FIG. 4, a method 400 relates to mitigating congestion on a port of a storage array's director board. In embodiments, the controller 142 of FIG. 1 can perform all or a subset of operations corresponding to the method 400.

For example, the method 400, at 402, can include receiving, at a storage array port, a peer congestion Fabric Performance Impact Notification (FPIN) message indicating congestion for a target port of the storage array. Additionally, at 404, the method 400 can include determining that the target port has not received a direct congestion FPIN message. The method 400, at 406, can also include inferring, based on the received peer congestion FPIN message and the determination, that the target port is experiencing congestion. Further, the method 400, at 408, can include controlling messaging to the target port to mitigate the congestion.

Using the teachings disclosed herein, a skilled artisan can implement the above-described systems and methods in digital electronic circuitry, computer hardware, firmware, or software. The implementation can be a computer program product. Additionally, the implementation can include a machine-readable storage device for execution by or to control the operation of a data processing apparatus. The implementation can, for example, be a programmable processor, a computer, or multiple computers.

A computer program can be in any programming language, including compiled or interpreted languages. The computer program can have any deployed form, including a stand-alone program, subroutine, element, or other units suitable for a computing environment. One or more computers can execute a deployed computer program.

One or more programmable processors can perform the method steps by executing a computer program to perform the concepts described herein by operating on input data and generating output. An apparatus can also perform the steps of the method. The apparatus can be a special-purpose logic circuitry. For example, the circuitry is an FPGA (field-programmable gate array) or an ASIC (application-specific integrated circuit). Subroutines and software agents can refer to portions of the computer program, the processor, the special circuitry, software, or hardware that implements that functionality.

Processors suitable for executing a computer program include, by way of example, both general and special purpose microprocessors and any one or more processors of any digital computer. A processor can receive instructions and data from a read-only memory, a random-access memory, or both. Thus, for example, a computer's essential elements are a processor for executing instructions and one or more memory devices for storing instructions and data. Additionally, a computer can receive data from or transfer data to one or more mass storage device(s) for storing data (e.g., magnetic, magneto-optical disks, solid-state drives (SSDs, or optical disks).

Data transmission and instructions can also occur over a communications network. Information carriers that embody computer program instructions and data include all nonvolatile memory forms, including semiconductor memory devices. The information carriers can, for example, be EPROM, EEPROM, flash memory devices, magnetic disks, internal hard disks, removable disks, magneto-optical disks, CD-ROM, or DVD-ROM disks. In addition, the processor and the memory can be supplemented by or incorporated into special-purpose logic circuitry.

A computer with a display device enabling user interaction can implement the above-described techniques, such as a display, keyboard, mouse, or any other input/output peripheral. The display device can, for example, be a cathode ray tube (CRT) or a liquid crystal display (LCD) monitor. The user can provide input to the computer (e.g., interact with a user interface element). In addition, other kinds of devices can enable user interaction. Other devices can, for example, be feedback provided to the user in any form of sensory feedback (e.g., visual feedback, auditory feedback, or tactile feedback). For example, input from the user can be in any form, including acoustic, speech, or tactile input.

A distributed computing system with a back-end component can also implement the above-described techniques. The back-end component can, for example, be a data server, a middleware component, or an application server. Further, a distributing computing system with a front-end component can implement the above-described techniques. The front-end component can, for example, be a client computer with a graphical user interface, a web browser through which a user can interact with an example implementation, or other graphical user interfaces for a transmitting device. Finally, the system's components can interconnect using any form or medium of digital data communication (e.g., a communication network). Examples of communication network(s) include a local area network (LAN), a wide area network (WAN), the Internet, a wired network(s), or a wireless network(s).

The system can include a client(s) and server(s). The client and server (e.g., a remote server) can interact through a communication network. For example, a client-and-server relationship can arise when computer programs run on the respective computers and have a client-server relationship. Further, the system can include a storage array(s) that delivers distributed storage services to the client(s) or server(s).

Packet-based network(s) can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network(s), 802.16 network(s), general packet radio service (GPRS) network, HiperLAN), or other packet-based networks. Circuit-based network(s) can include, for example, a public switched telephone network (PSTN), a private branch exchange (PBX), a wireless network, or other circuit-based networks. Finally, wireless network(s) can include RAN, Bluetooth, code-division multiple access (CDMA) networks, time division multiple access (TDMA) networks, and global systems for mobile communications (GSM) networks.

The transmitting device can include, for example, a computer, a computer with a browser device, a telephone, an IP phone, a mobile device (e.g., cellular phone, personal digital assistant (PDA) device, laptop computer, electronic mail device), or other communication devices. The browser device includes, for example, a computer (e.g., desktop computer, laptop computer) with a World Wide Web browser (e.g., Microsoft® Internet Explorer® and Mozilla®). The mobile computing device includes, for example, a Blackberry®.

Comprise, include, or plural forms of each are open-ended, include the listed parts, and contain additional unlisted elements. Unless explicitly disclaimed, the term ‘or’ is open-ended and includes one or more of the listed parts, items, elements, and combinations thereof.

What is claimed is:

1. A method comprising:
receiving, at a storage array port, a peer congestion Fabric Performance Impact Notification (FPIN) message indicating congestion for a target port of the storage array;
determining that the target port has not received a direct congestion FPIN message;
inferring, based on the received peer congestion FPIN message and the determination, that the target port is experiencing congestion; and
controlling messaging to the target port to mitigate the congestion.

2. The method of claim 1, further comprising:
inspecting multiple ports of the storage array to identify received peer congestion FPIN messages related to the target port.

3. The method of claim 2, further comprising:
inspecting all ports of the storage array in a specific zone of the storage array corresponding to the target port to identify ports receiving peer congestion FPINs for the target port.

4. The method of claim 1, further comprising:
extracting, from the peer congestion FPIN message, a World Wide Name (WWN) of the target port experiencing congestion.

5. The method of claim 3, further comprising:
searching a connectivity table of the storage array for the extracted WWN of the target port.

6. The method of claim 4, further comprising:
searching the connectivity table of the storage array to identify a switch port WWN connected to the target port.

7. The method of claim 1, further comprising:
adjusting bandwidth limits on the target port to mitigate the inferred congestion on the target port.

8. The method of claim 1, further comprising:
receiving the peer congestion FPIN message on a subject storage array port on a zone corresponding to the target port.

9. The method of claim 1, further comprising:
determining whether the congestion on the target port is preventing the target port from receiving a direct congestion FPIN message.

10. The method of claim 1, further comprising:
generating a congestion notification for the target port as if the target port had received a direct congestion FPIN message from a connected switch port.

11. An apparatus with a memory and processor, the apparatus configured to:
receive, at a storage array port, a peer congestion Fabric Performance Impact Notification (FPIN) message indicating congestion for a target port of the storage array;
determine that the target port has not received a direct congestion FPIN message;
infer, based on the received peer congestion FPIN message and the determination, that the target port is experiencing congestion; and
control messaging to the target port to mitigate the congestion.

12. The apparatus of claim 11, further configured to:
inspect multiple ports of the storage array to identify received peer congestion FPIN messages related to the target port.

13. The apparatus of claim 12, further configured to:
inspect all ports of the storage array in a specific zone of the storage array corresponding to the target port to identify ports receiving peer congestion FPINs for the target port.

14. The apparatus of claim 11, further configured to:
extract, from the peer congestion FPIN message, a World Wide Name (WWN) of the target port experiencing congestion.

15. The apparatus of claim 13, further configured to:
search a connectivity table of the storage array for the extracted WWN of the target port.

16. The apparatus of claim 14, further configured to:
search the connectivity table of the storage array to identify a switch port WWN connected to the target port.

17. The apparatus of claim 11, further configured to:
adjust bandwidth limits on the target port to mitigate the inferred congestion on the target port.

18. The apparatus of claim 11, further configured to:
receive the peer congestion FPIN message on a subject storage array port on a zone corresponding to the target port.

19. The apparatus of claim 11, further configured to:
determine whether the congestion on the target port is preventing the target port from receiving a direct congestion FPIN message.

20. The apparatus of claim 11, further configured to:
generate a congestion notification for the target port as if the target port had received a direct congestion FPIN message from a connected switch port.
